(19) United States
(12) Patent Application Publication
(10) Pub. No.: US 2017/0097470 A1
(43) Pub. Date: Apr. 6, 2017

(54) Optical Coupling Adaptor for Optical Signal Coupling Between Photonic Integrated Circuit and Optical Fiber

(71) Applicant: Jia Jiang, Ottawa (CA)

(72) Inventor: Jia Jiang, Ottawa (CA)

(21) Appl. No.: 14/873,733

(22) Filed: Oct. 2, 2015

(51) Int. Cl. G02B 6/30; G02B 6/138; G02B 6/14

(52) U.S. Cl. CPC G02B 6/305; G02B 6/14; G02B 6/138; G02B 2006/12097

(57) ABSTRACT

An optical coupling adaptor couples an optical fiber to a photonic integrated circuit (PIC) chip. The adaptor once connected to the PIC chip forms a chip-adaptor assembly. The photonic integrated circuit (PIC) chip has a plurality of inverted taper waveguides having an enlarged optical mode. The optical coupling adaptor has a first section having a plurality of ridge waveguides between layers of cladding and also separated laterally by cladding and a second section abutting the first section, the second section having a plurality of trenches each filled with an optical polymer that Once cured has a refractive index that matches that of the ridge waveguides. The optical coupling adaptor is adhered to the PIC chip using the optical polymer as an adhesive such that the optical polymer in the trenches once cured form polymer waveguides that confine the enlarged mode of the inverted taper waveguides.

### TECHNICAL FIELD

The present disclosure generally relates to fiber optics and, more particularly, optical coupling adaptors for coupling optical signals between an optical fiber and a photonic integrated circuit (PIC) chip.

### BACKGROUND

A photonic integrated circuit (PIC) based on a silicon-on-insulator (SOI) platform is highly compact and exhibits a high level of functional integration due to its high index contrast. As such, PIC chips on an SOI platform provide advantages of speed, compactness and a low cost per bit for optical communication.

The silicon waveguide cross-section of a PIC chip is usually on a sub-micron scale. To implement the SOI chip in an optical data transmission network, the photonic integrated circuit (PIC) must be connected with optical fibers to enable the optical signal to transmit on/off the chip. However, coupling optical fibers with a PIC chip is challenging because of a number of factors.

Firstly, to increase the PIC functional capability and capacity, a large number of optical fibers usually must be connected to the small PIC chip. A large number of edge couplers is required at the edge of the PIC chip. The pitch of the edge coupler is very small, for example 20 μm, in order to accommodate more couplers in the limited space of the PIC edge. However, the diameter of the fiber is usually 250 μm. This pitch mismatch is illustrated in FIG. 1. It is difficult and/or expensive to make the fiber array achieve a pitch of 20 μm using standard, commercially available fiber.

Secondly, the mode field dimension (MFD) of optical fiber is about 10 μm for most commercial fibers. For coupling the fiber optical mode into a sub-micron photonic waveguide, e.g. a silicon waveguide whose dimension is usually 500 nm×220 mn, there is a huge mismatch between them as shown in FIG. 2. This mismatch gives rise to significant loss at the interface. Maximizing the overlap integral between the two modes is the only way to minimize the coupling loss between the fiber and the chip.

Thirdly, in a chip-to-fiber packaging process directly connecting the fiber to the chip by a fiber array, fiber-waveguide alignment is challenging. Furthermore, the aligned fiber might shift post packaging from its original packaged position when environmental parameters such as temperature and/or humidity change.

Addressing these factors makes conventional fiber-to-chip packaging processes very time-consuming and costly. Accordingly, a novel optical coupling adaptor and method of coupling a PIC chip to an optical fiber are highly desirable.

### SUMMARY

The following presents a simplified summary of some aspects or embodiments of the invention in order to provide a basic understanding of the invention. This summary is not an extensive overview of the invention. It is not intended to identify key or critical elements of the invention or to delineate the scope of the invention. Its sole purpose is to present some embodiments of the invention in a simplified form as a prelude to the more detailed description that is presented later.

The present specification discloses an optical coupling adaptor that efficiently couples optical signals between a photonic integrated circuit (PIC) chip and an optical fiber, or array of fibers, that have different pitches. In other words, the optical coupling adaptor acts as an edge coupling device that effectively expands the narrow waveguide mode of the PIC to a wide fiber mode, enabling efficient (low-loss) coupling of the PIC chip with optical fiber.

One inventive aspect of the disclosure is an optical coupling adaptor for connecting optically a photonic integrated circuit (PIC) chip with an optical fiber. The optical coupling adaptor includes a first section having a base layer of cladding, a plurality of ridge waveguides formed on the base layer and separated by cladding, and a top layer of cladding over the ridge waveguides. The optical coupling adaptor includes a second section having a base layer of cladding and a plurality of trenches, wherein the trenches abut the ridge waveguides to form continuous waveguides that transmit and confine an enlarged optical mode of inverted taper waveguides of the PIC chip. The second section connects to the first section and wherein a height of the second section is smaller than a height of the first section.

Another inventive aspect of the disclosure is a chip-adaptor assembly that includes a photonic integrated circuit (PIC) chip having a plurality of inverted taper waveguides having an enlarged optical mode and an optical coupling adaptor. The adaptor has a first section having a plurality of ridge waveguides between layers of cladding and also separated laterally by cladding and a second section abutting the first section, the second section having a plurality of trenches each filled with an optical polymer that once cured has a refractive index that matches that of the ridge waveguides. The optical coupling adaptor is adhered to the PIC chip using the optical polymer as an adhesive such that the optical polymer in the trenches once cured form polymer waveguides that confine the enlarged mode of the inverted taper waveguides.

Yet another inventive aspect of the disclosure is a method of connecting an optical coupling adaptor to a photonic integrated circuit (PIC) chip. The method entails providing a photonic integrated circuit (PIC) chip having a plurality of inverted taper waveguides having an enlarged optical mode, providing an optical coupling adaptor having a first section having a plurality of ridge waveguides between layers of cladding and also separated laterally by cladding and having a second section abutting the first section, the second section having a plurality of trenches, filling the plurality of trenches with an optical polymer, mating the optical coupling adaptor with the PIC chip, and curing the optical polymer to adhere the optical coupling adaptor to the PIC chip to furthermore cause the optical polymer once cured to exhibit a refractive index that matches that of the ridge waveguides to form polymer waveguides that confine the enlarged mode of the inverted taper waveguides.

### BRIEF DESCRIPTION OF THE DRAWINGS

These and other features of the disclosure will become more apparent from the description in which reference is made to the following appended drawings.

FIG. 1 depicts an array pitch mismatch between an optical fiber and a silicon waveguide of a PIC that arises with prior-art edge couplers.

FIG. 2 depicts a mode mismatch between an optical fiber and a silicon waveguide of a photonic integrated circuit (PIC) that arises with prior-art edge couplers.

FIG. 3 is a perspective, partially transparent view of an optical coupling adaptor in accordance with one embodiment of the present invention, shown connected to a PIC chip.

FIG. 4 is a top view of an optical coupling adaptor having four waveguides in accordance with another embodiment.

FIG. 5 is a perspective view of the optical coupling adaptor having five waveguides in accordance with another embodiment.

FIG. 6 is a perspective view of an optical coupling adaptor having two waveguides.

FIG. 7 depicts the optical coupling adaptor of FIG. 6 being used in a method of packaging the adaptor with a PIC chip.

FIG. 8 depicts the liquid optical polymer being dropped into an inverted silicon taper waveguide in the PIC chip.

FIG. 9 depicts a first step of a soft lithography method for creating the polymer optical coupling adaptor in which firstly a polymer patterned mold (e.g. PDMS or equivalent) is provided.

FIG. 10 depicts a second step in which the core polymer (e.g. SU-8) is poured into the

FIG. 11 depicts a third step in which, after any excess polymer has been removed to create a flat top surface, the core polymer is UV-cured or thermally cured.

FIG. 12 depicts a fourth step in which a cladding polymer (having a lower index than that of the core polymer) is coated on the top surface and then cured.

FIG. 13 depicts a fifth step in which the cladding and core layer are peeled from the mold.

FIG. 14 depicts a sixth step in which the cladding and core layer are inverted.

FIG. 15 is a side view of the adaptor, depicting a seventh step of coating a top cladding over the ridge waveguide section while leaving the trench area uncoated.

FIG. 16 depicts an adaptor that is part of an interposer for changing the pitch to match an array of optical fibers.

FIG. 17 is a flowchart depicting a method of making a chip-adaptor assembly for use in chip-to-fiber coupling.

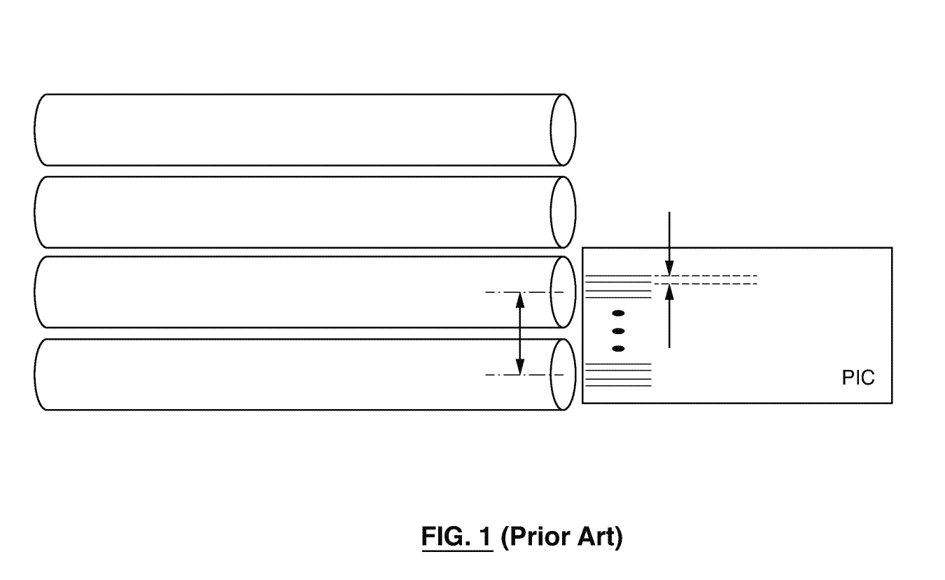

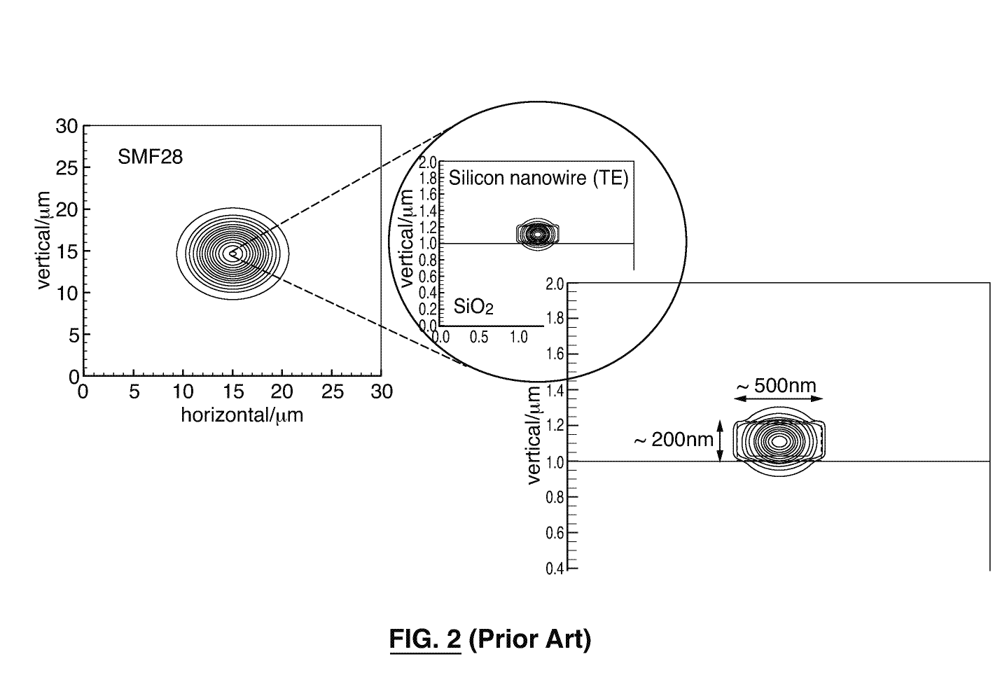

### DETAILED DESCRIPTION OF EMBODIMENTS

The following detailed description contains, for the purposes of explanation, numerous specific embodiments, implementations, examples and details in order to provide a thorough understanding of the invention. It is apparent, however, that the embodiments may be practiced without these specific details or with an equivalent arrangement. In other instances, some well-known structures and devices are shown in block diagram form in order to avoid unnecessarily obscuring the embodiments of the invention. The description should in no way be limited to the illustrative implementations, drawings, and techniques illustrated below, including the exemplary-designs and implementations illustrated and described herein, but may be modified within the scope of the appended claims along with their full scope of equivalents.

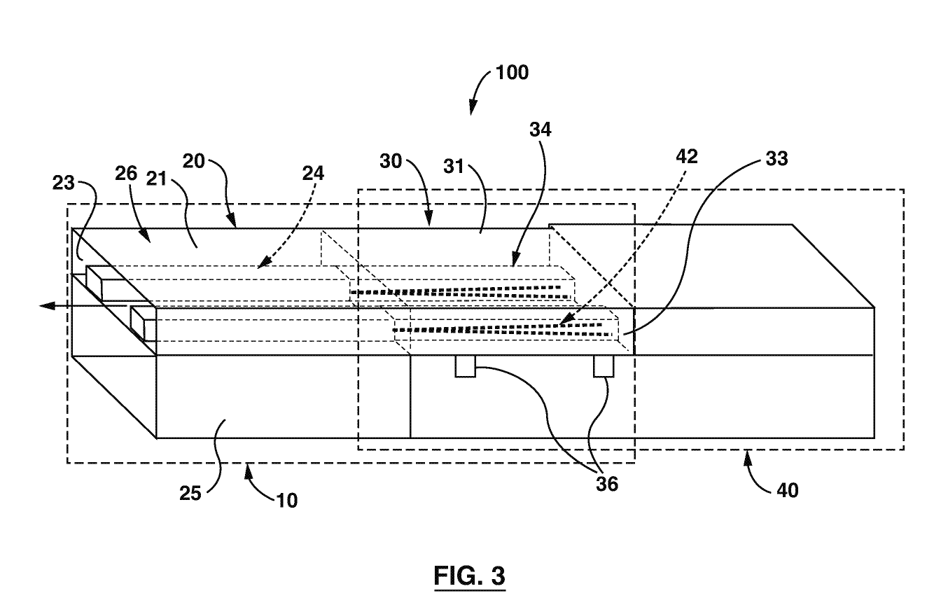

In the embodiment shown by way of example in FIG. 3, an optical coupling adaptor (also referred to herein as a “chip adaptor”) is denoted by reference numeral 10. The optical coupling adaptor in the illustrated embodiment of FIG. 3 is a chip based on a polymer material or silica-on-silicon or any suitable equivalent. The optical coupling adaptor 10 is designed to couple one or more optical fibers, typically an array of fibers, to respective waveguides of a photonic integrated circuit (PIC) chip 40. The optical coupling adaptor is bidirectional, i.e. able to transmit optical signals from the PIC chip to the optical fibers or vice versa.

In the embodiment depicted in FIG. 3, the optical coupling adaptor 10 includes two sections, namely a first section 20 and a second section 30 abutting the first section as shown by way of example in FIG. 3. In the illustrated embodiment, the second section 30 has a height smaller than that of the first section 20. In the illustrated embodiment, the first and second sections 20, 30 are integrally formed. In the first section 20, one or more ridge waveguides 24 are embedded in the cladding layer. One end of the ridge waveguides 24 is spaced to match the pitch of a commercial optical fiber array. Its waveguide dimension is selected so that the optical mode matches the scale of the fiber mode diameter. The other end of the one or more ridge waveguides 24 connects to, i.e. abuts or adjoins, the trenches 34 of the second section. The ridge waveguides 24 of the first section 20 and trenches 34 of the second section have the same cross-sectional dimensions. The second section 30 of the optical coupling adaptor 10 is designed to engage or mate with the PIC chip 40. Once connected (i.e. mated and bonded together) the optical coupling adaptor 10 and the PIC chip constitute a chip-adaptor assembly 100.

As depicted by way of example in FIG. 3, the first section has a base layer 21 of cladding, the plurality of ridge waveguides 24 formed on the base layer 21. The ridge waveguides are also separated by side cladding 23 and covered by a top layer 25 of cladding over the ridge waveguides. The second section 30 has a base layer of cladding 31 and side cladding 33 between the trenches 34.

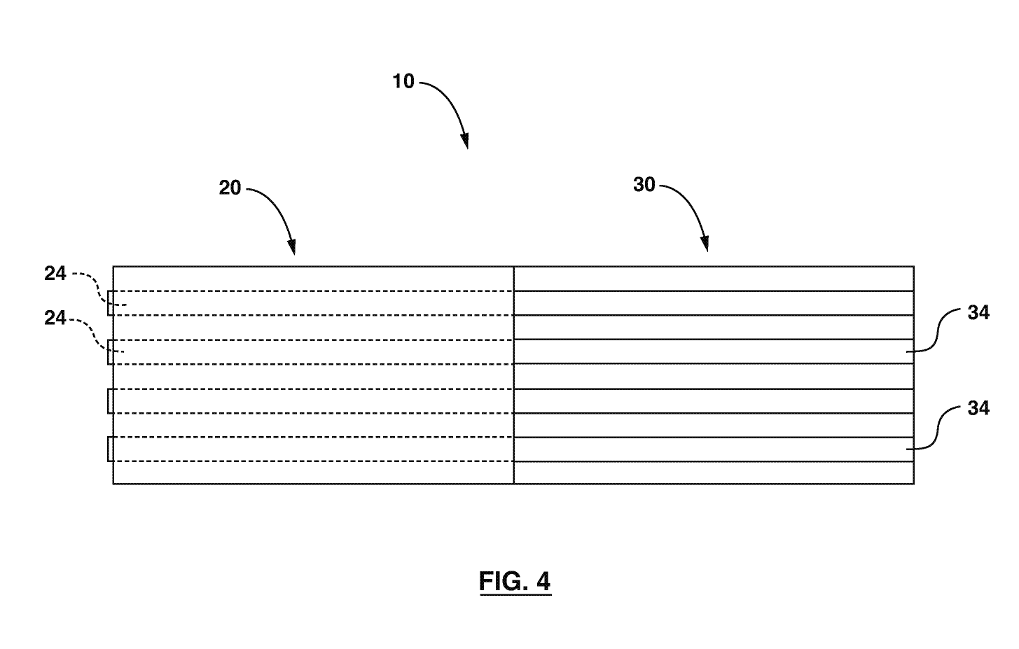

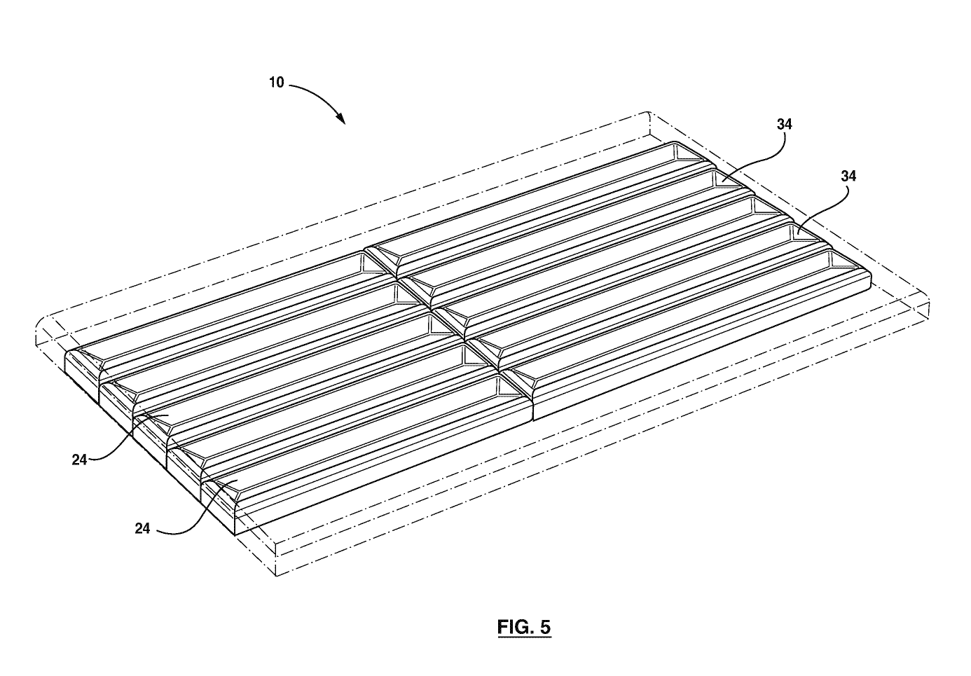

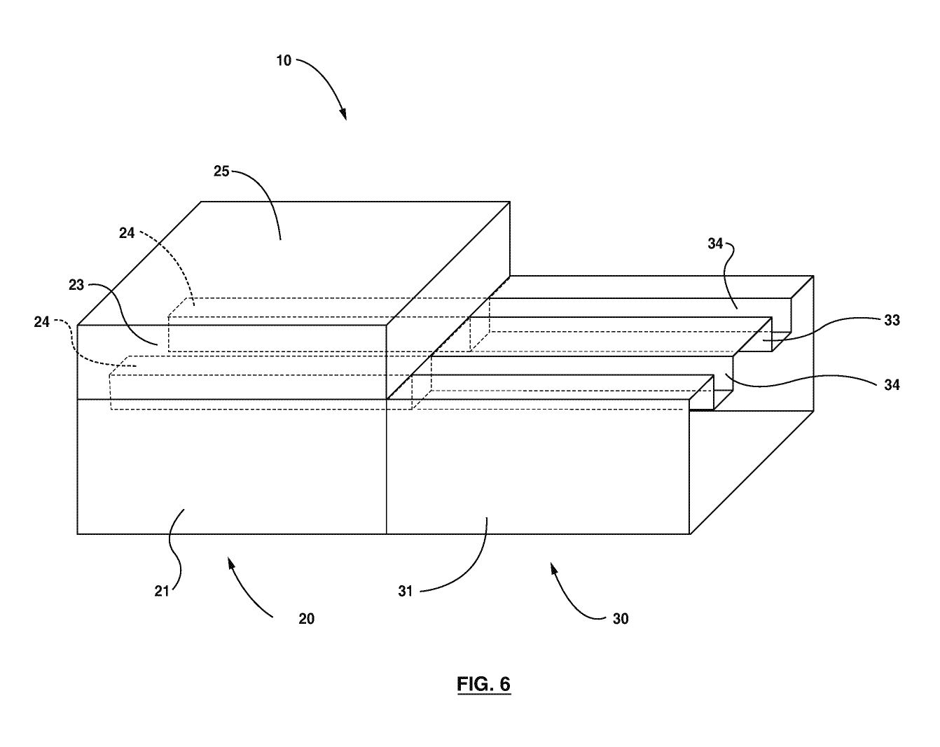

As illustrated by way of example in FIGS. 4, 5 and 6, the ridge waveguides 24 and trenches 34 form parallel and equally spaced apart continuous waveguides. In the embodiment of FIG. 4, there are four ridge waveguides abutting four respective trenches. In the embodiment of FIG. 5, there are five ridge waveguides abutting five respective trenches. In the embodiment of FIG. 6, there are two ridge waveguides abutting two respective trenches. These trenches are designed to be filled with a curable optical polymer liquid, solution or gel-like substance having a sufficiently low viscosity to flow into and fill the trenches. In each of these three figures, the trenches are parallel and equally spaced apart as are the ridge waveguides. However, in other embodiments, the pattern of the ridge waveguides and the trenches could be a fan-in/fan-out configuration to match the pitch of the fiber array on one side and the chip edge coupling waveguide array on the other side. A top cladding layer with the same height of the top SiO₂ cladding thickness in the PIC chip is coated on the ridge waveguide area (of the first section 20) on the optical coupling adaptor 10. The trench area (in the second section 30) remains uncoated in the illustrated embodiment. As shown by way of example in FIG. 3, alignment markers 36 may be provided at predetermined locations on second section 30 of the optical coupling adaptor 10 to facilitate assembly with the PIC chip.

On the PIC chip 40, the inverted edge coupler is designed without a top silica cladding. A small amount of the optical polymer liquid or solution 50 is dropped, deposited or otherwise placed on the surface of the taper waveguide region before the adaptor 10 and PIC chip 40 are attached. The polymer material 50 is the same material as, or has the same refractive index as, that of the ridge waveguide in the first section 20 of the optical coupling adaptor 10. After the polymer liquid 50 is deposited, the optical coupling adaptor 10 is flipped over inverted) and mated with the PIC chip 40 such that the trenches of the optical coupling adaptor 10 align with and overlap the inverted taper waveguides of the NC chip 40. The adapter is pressed gently onto the PlC chip, thereby causing the curable polymer solution 50 to fill the trenches 34. The curable optical polymer is then cured thermally or optically (e.g., with ultraviolet light). After having cured the optical polymer within the trenches, the optical coupling adaptor 10 and the PIC chip 40 are tightly stacked and bonded to one another. The polymer in the trench acts as the waveguide which effectively confines and transmits the optical mode enlarged by the inverted silicon taper waveguide. Furthermore, no further adhesive is required to bond the optical coupling adaptor to the PIC chip because the optical polymer 50 plays the dual roles of both optical waveguide material and adhesive. In addition to confining the enlarged mode, the adaptor has the effect of vertically increasing the waveguide height (as measured from the chip plane).

The PIC chip 40 is usually designed with inverted taper waveguides as edge couplers. The effective index of the waveguide decreases as the taper narrows. Accordingly, the optical mode in the taper waveguide is enlarged. At the tip, the optical mode matches that of the optical fiber. Without the polymer-filled trenches, the enlarged optical mode of the inverted taper waveguide would be weakly confined due to the lack of proper confinement structure. A large amount of light would be lost by light scattering in the plane of the waveguide. With the chip adaptor disclosed herein, the new waveguide created by the optical polymer 50 in the trenches 34 acts as the waveguide that confines and transmits the enlarged optical mode from the inverted taper waveguide through the polymer-filled trenches to the end of the chip adaptor where the optical fibers are connected. This enables the PIC chip to couple light to the optical fibers with a substantially lower coupling loss.

In the first section 20 of the adaptor chip 10, one end of the ridge waveguide 24 connects to the end of the respective trench 34. In other words, the ridge waveguides are aligned and abut (adjoin) the respective polymer-filled trenches to together constitute a continuous waveguide when the adaptor stacks on the PIC chip. The continuous waveguide exhibits a lower coupling loss compared with traditional edge coupling that directly connects to fiber or that uses an interposer as a pitch reducer/mode convertor between fiber and chip.

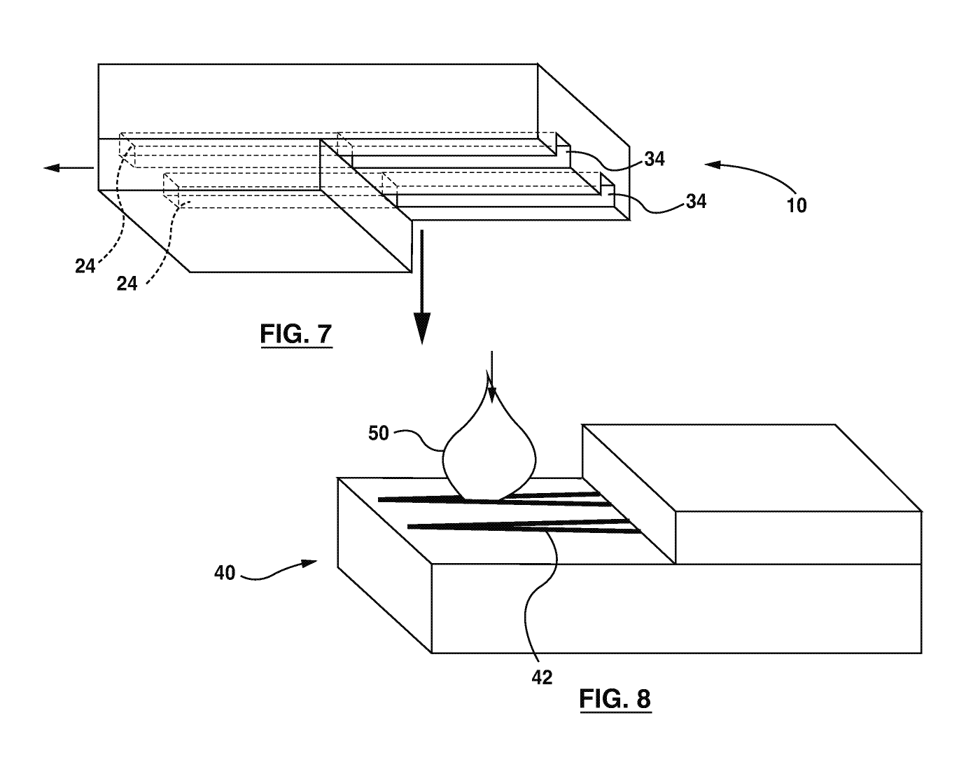

As shown by way of example in FIGS. 7 and 8, the adaptor chip 10 is flipped over to mate with the PIC chip 40. Due to the height difference of the cladding in the inverted taper area of the PIC chip and the presence of alignment markers, the adaptor chip 10 is easily aligned and connected to the PIC. chip such that the trenches 34 align with the inverted taper waveguides 42 of the PIC chip. Due to the overlap of the waveguide portion of the PIC chip 40 with the trench portion of the adaptor 10, the resulting physical connection between the PIC chip and the adaptor is strong and stable. The optical polymer 50 performs both the functions of waveguide and chip adhesion. No additional adhesive is required thus simplifying the packaging process and lowering the packaging cost. As such, it may be said that the optical coupling adaptor is multifunctional since its polymer-filled trenches act both as a waveguide for the enlarged mode and as an adhesive to bond the adaptor to the PIC chip.

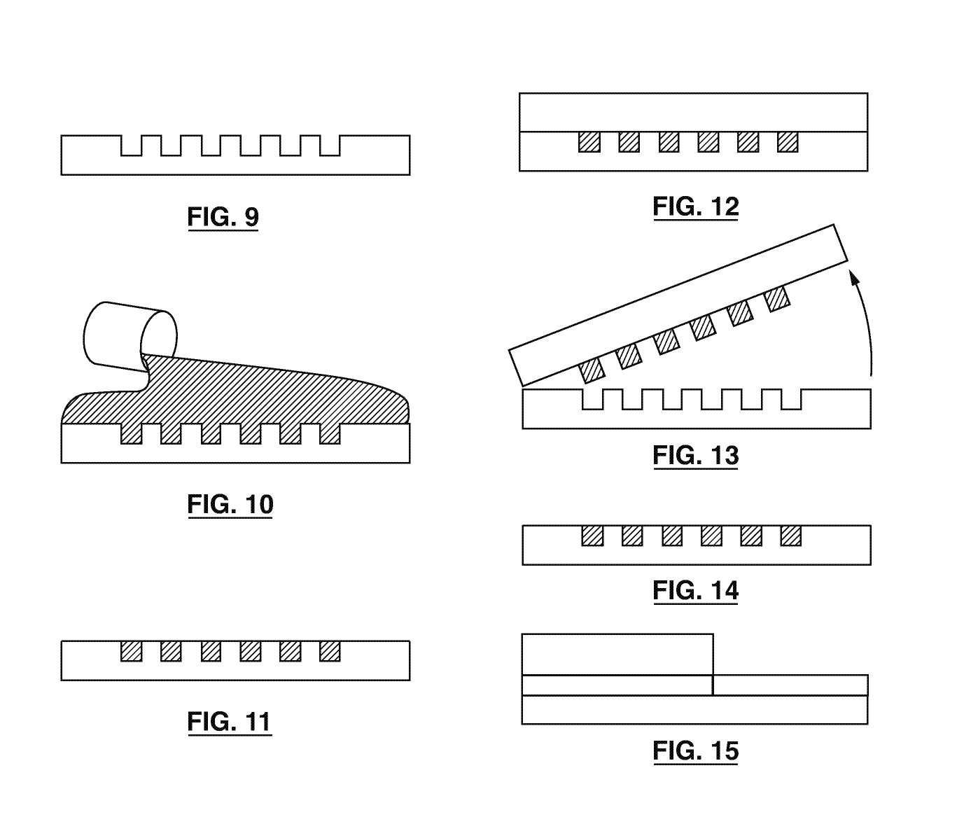

Soft lithography may be used to fabricate the chip adaptor 10 since it is useful for making polymer waveguide devices. As shown in FIG. 9, a first step of a soft lithography method for creating the polymer optical coupling adaptor involves providing a polymer patterned mold (e.g. PDMS or equivalent). As shown in FIG. 10, in a second step, the core polymer (e.g. SU-8 or other optical polymer) is poured into the mold. FIG. 11 depicts a third step in which, after any excess polymer has been removed to create a flat top surface, the core polymer is UV-cured or thermally cured, FIG. 12 depicts a fourth step in which a cladding polymer (having a lower index than that of the core polymer) is coated on the top surface and then cured. As shown in FIG. 13, the cladding and core layer are peeled from the mold. The cladding and core layer are then inverted and then coated with a layer of cladding to create lengths of side cladding between adjacent ridges. The result is shown in FIG. 14. As shown in FIG. 15, a top cladding is coated over the ridge waveguide section white leaving the trench area uncoated. This soft lithography method is useful for producing an all-polymer-based optical coupling adaptor since it is easy, simple and tow cost. If necessary, the refractive index of the polymer can be adjusted to match the mode effective index of the waveguide and fiber.

Alternatively, for a silica-based optical coupling adaptor, planar lightwave circuit (PLC) technology (e.g. silica-on-silicon) can be used cost-effectively for design and fabrication. Reactive ion etching could also be used for fabrication.

For the embodiments disclosed herein, the optical coupling adaptor 10 creates waveguides able to confine the mode enlarged by the inverted the taper waveguide. This significantly reduces the inverted taper edge coupler toss. The optical coupling adaptor 10 can be designed with different sizes and geometries. The size and geometry of the ridges and trenches of the optical coupling adaptor 10 can be designed to match the characteristics of the inverted taper waveguides and the pitch of the fiber optic array. Although a PIC chip with silicon waveguides is described herein, it will be appreciated that the adaptor may be used with other PIC chips having waveguides made of other semiconductor materials, e.g. Group III-IV-V materials.

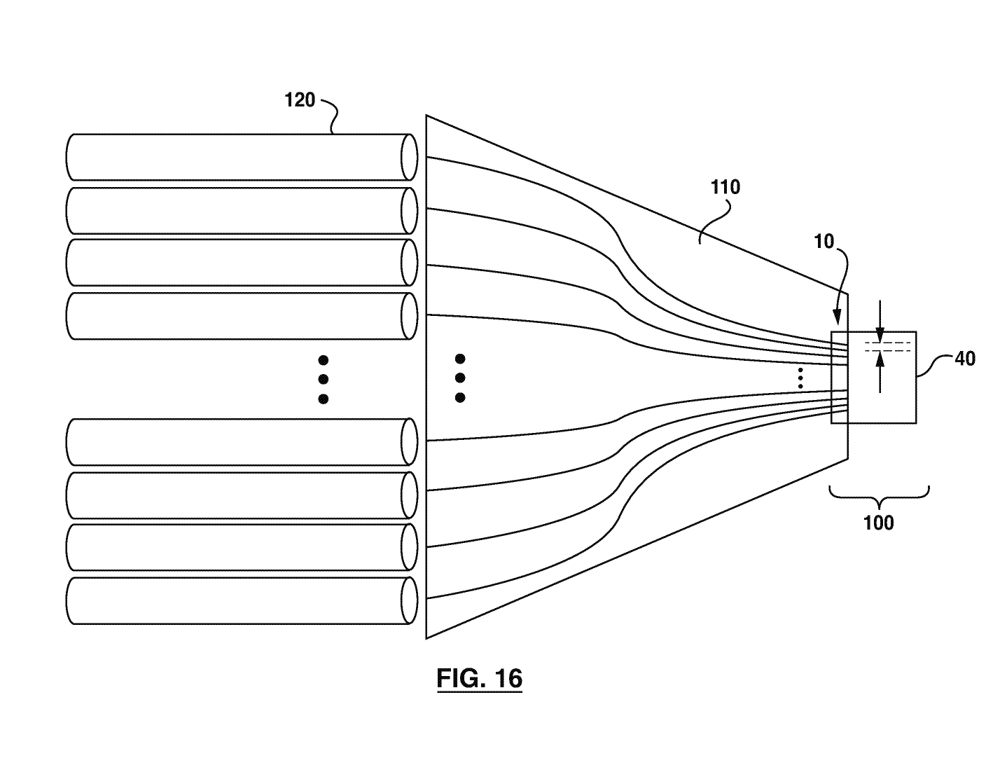

FIG. 16 depicts an interposer 110 incorporating the adaptor 10. This interposer changes the pitch to match an array of optical fibers 120 by fanning the waveguides outwardly to match the fiber pitch. The ridge waveguides 24 in the first section 20 of the optical coupling adaptor 10 may be designed in a fan-in/fan-out arrangement to match the optical fiber array at one end and the PIC chip edge waveguide array at the other end. A fanned design performs the function of a traditional interposer of pitch reduction or mode conversion.

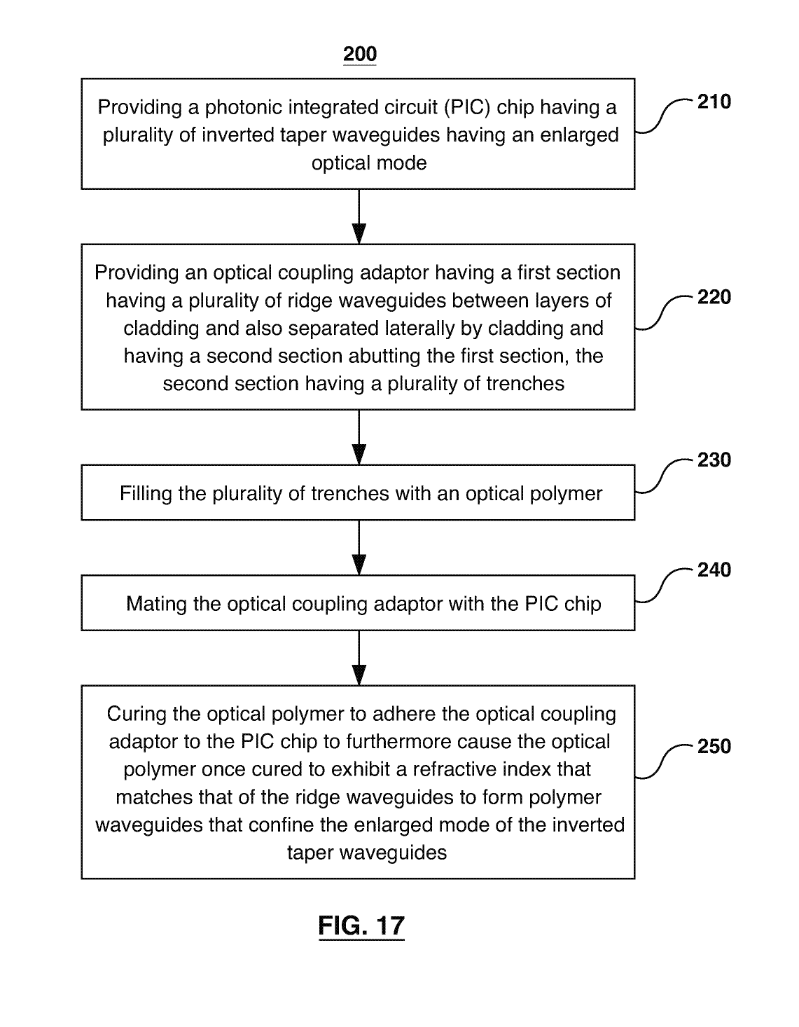

The chip-adaptor assembly 100 of FIG. 3 can be made by a method (200) that entails, as illustrated in FIG. 17, the following acts, steps or operations: providing (210) a photonic integrated circuit (PIC) chip having a plurality of inverted taper waveguides, e.g. silicon waveguides, having an enlarged optical mode, providing (220) an optical coupling adaptor having a first section having a plurality of ridge waveguides between layers of cladding and also separated laterally by cladding and having a second section abutting the first section, the second section having a plurality of trenches, filling (230) the plurality of trenches with an optical polymer, mating (240) the optical coupling adaptor with the PIC chip and curing (250) the optical polymer to adhere the optical coupling adaptor to the PIC chip to furthermore cause the optical polymer once cured to exhibit a refractive index that matches that of the ridge waveguides to form polymer waveguides that confine the enlarged mode of the inverted taper waveguides. The optical polymer may be polyimide, perfluorinated polymer or polyacrylate or any other equivalent or suitable material. The method may involve forming trenches having a cross-sectional area equal to that of the ridge waveguides and wherein the trenches and ridge waveguides are parallel and equally spaced apart.

The optical coupling adaptor disclosed herein could be used to couple any suitable photonic integrated circuit chip to one or more optical fibers for the purposes of transmitting and/or receiving optical signals to and from the one or more optical fibers. The adaptor can provide fiber-to-PIC coupling for a variety of optical telecommunication technologies including, but not limited to, metro optical core networks, wireless aggregation networks or Cloud Radio Access Networks (C-RAN), data center transceivers, data center core switching networks, coherent optical transceivers in metro and long-haul networks.

It is to be understood that the singular forms “a”, “an” and “the” include plural referents unless the context clearly dictates otherwise, Thus, for example, reference to “a device” includes reference to one or more of such devices, i.e. that there is at least one device. The terms “comprising”, “having”, “including” and “containing” are to be construed as open-ended terms (i.e., meaning “including, but not limited to,”) unless otherwise noted. All methods described herein can be performed in any suitable order unless otherwise indicated herein or otherwise clearly contradicted by context. The use of examples or exemplary language (e.g. “such as”) is intended merely to better illustrate or describe embodiments of the invention and is not intended to limit the scope of the invention unless otherwise claimed.

While several embodiments have been provided in the present disclosure, it should be understood that the disclosed systems and methods might be embodied in many other specific forms without departing from the scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the inventive concept(s) disclosed herein.

1. An optical coupling adaptor for coupling a photonic integrated circuit (PIC) chip with an optical fiber, the optical coupling adaptor comprising:
a first section having a base layer of cladding, a plurality of ridge waveguides formed on the base layer and separated by cladding, and a top layer of cladding over the ridge waveguides; and
a second section having a base layer of cladding and a plurality of trenches, wherein the trenches abut the ridge waveguides to form continuous waveguides that transmit and confine an enlarged optical mode of inverted taper waveguides of the PIC chip;
wherein the second section connects to the first section and wherein a height of the second section is smaller than a height of the first section.

2. The optical coupling adaptor of claim 1 wherein the trenches are each fillable with an optical polymer that once cured inside the trenches has a refractive index that matches a refractive index of the ridge waveguides.

3. The optical coupling adaptor of claim 1 wherein a cross-sectional area of each trench is equal to a cross-sectional area of each ridge waveguide.

4. The optical coupling adaptor of claim 1 wherein the trenches and ridge waveguides are parallel and equally spaced apart.

5. The optical coupling adaptor of claim 1 wherein the ridge waveguides fan outwardly to match a pitch of an array of optical fibers.

6. The optical coupling adaptor of claim 1 wherein the inverted taper waveguides are silicon waveguides.

7. The optical coupling adaptor of claim 1 wherein the optical polymer is one of polyimide, perfluorinated polymer or polyacrylate.

8. A chip-adaptor assembly comprising:
a photonic integrated circuit (PIC) chip having a plurality of inverted taper waveguides having an enlarged optical mode;
an optical coupling adaptor having:
a first section having a plurality of ridge waveguides between layers of cladding and also separated laterally by cladding; and
a second section abutting the first section, the second section having a plurality of trenches each filled with an optical polymer that once cured has a refractive index that matches that of the ridge waveguides;
wherein the optical coupling adaptor is adhered to the PIC chip using the optical polymer as an adhesive such that the optical polymer in the trenches once cured form polymer waveguides that confine the enlarged mode of the inverted taper waveguides.

9. The chip-adaptor assembly of claim 8 wherein the trenches have a cross-sectional area equal to that of the ridge waveguides.

10. The chip-adaptor assembly of claim 8 wherein the trenches and ridge waveguides are parallel and equally spaced apart.

11. The chip-adaptor assembly of claim 8 wherein the ridge waveguides fan outwardly to match a pitch of an array of optical fibers.

12. The chip-adaptor assembly of claim 8 wherein the inverted taper waveguides are silicon waveguides.

13. The chip-adaptor assembly of claim 8 wherein the optical polymer is one of polyimide, perfluorinated polymer or polyacrylate.

14. A method of making a chip-adaptor assembly for use in coupling a photonic integrated. circuit (PIC) chip to an optical fiber, the method comprising:
providing a photonic integrated circuit (PIC) chip having a plurality of inverted taper waveguides having an enlarged optical mode;
providing an optical coupling adaptor having a first section having a plurality of ridge waveguides between layers of cladding and also separated laterally by cladding and having a second section abutting the first section, the second section having a plurality of trenches;
filling the plurality of trenches with an optical polymer;
mating the optical coupling adaptor with the PIC chip; and
curing the optical polymer to adhere the optical coupling adaptor to the :PIC chip to furthermore cause the optical polymer once cured to exhibit a refractive index that matches that of the ridge waveguides to form polymer waveguides that confine the enlarged mode of the inverted taper waveguides.

15. The method of claim 14 wherein the trenches have a cross-sectional area equal to that of the ridge waveguides.

16. The method of claim 14 wherein the trenches and ridge waveguides are parallel and equally spaced apart.

17. The method of claim 14 wherein the ridge waveguides fan outwardly to match a pitch of an array of optical fibers.

18. The method of claim 14 wherein the inverted taper waveguides are silicon waveguides.

19. The method of claim 14 wherein curing the optical polymer comprises curing any one of polyimide, perfluorinated polymer or polyacrylate as the optical polymer.
